(19) United States
(12) Patent Application Publication
(10) Pub. No.: US 2005/0233725 A1
(43) Pub. Date: Oct. 20, 2005

(54) Image reject filtering in a direct sampling mixer

(76) Inventors: Khurram Muhammad, Dallas, TX (US); Robert B. Staszewski, Garland, TX (US); Dirk Leipold, Plano, TX (US)

Correspondence Address: TEXAS INSTRUMENTS INCORPORATED, P O BOX 655474, M/S 3999, DALLAS, TX, 75265, US

(21) Appl. No.: 10/828,386

(22) Filed: Apr. 20, 2004

(51) Int. Cl. H04B 1/16

(52) U.S. Cl. 455/339

(57) ABSTRACT

Disclosed are methods, circuits and systems for image reject filtering in a multi-tap direct sampling mixer (MTDSM) of an IF or RF system. Disclosed is the use of rotating capacitors among the in-phase and quadrature branches of a signal processing system. The exchange of information among the branches of the I and Q channels is used in the implementation of a complex filter. Embodiments using cascaded multiple stages of the complex filter to provide higher order complex filters are also disclosed.

### RELATED APPLICATIONS

This application is related to patent application, Ser. No. ______ (attorney docket number TI-34776), which is incorporated herein in its entirety for all purposes by this reference.

### TECHNICAL FIELD

The invention relates to signal processing circuits and methods. More particularly, the invention relates to methods and circuits for image reject filtering in a direct sampling mixer.

### BACKGROUND OF THE INVENTION

Integrated radio transmitters and receivers have become increasingly popular. Efforts to provide intermediate frequency (IF) and radio frequency (RF) devices integrated on a single chip face many challenges. One problem in particular is the need to suppress or reject image signals by providing band-pass filtering in transceiver devices designed for portable wireless applications. Such applications require low power consumption, low silicon area, low external component count and a high degree of single-chip integration.

Quadrature signaling schemes are known in the arts. Quadrature signaling incorporates techniques of processing an input in terms of an in-phase signal component (I) and a quadrature (Q) signal component using a carrier frequency source and a (typically ninety-degree) phase shifter. Another prior art approach uses a 2× oscillator and a divide-by-two that gives 90 degree spaced clocks. Precise matching of quadrature signal components is difficult to realize, however, particularly at higher frequencies. Various RC networks have been used in the arts in efforts to provide high frequency filtering. Single and multistage RC networks may be used in some situations, but are generally susceptible to RC mismatch, are limited to narrow-band applications, and are increasingly difficult to implement for higher frequency applications.

Switched capacitor filters are sometimes used in attempts to overcome some of the difficulties inherent in RC filter implementations. Switched capacitors can provide an alternative approach to the implementation of RC designs. It is known that a capacitor electrically coupled and switched between two contact points can be made to function like a resistor coupled between the two points. Switched capacitor filter implementations known in the arts substitute capacitors for resistors in RC networks. As in typical RC networks, op amps are generally used to provide the needed gain. The switched capacitor implementation eliminates the problem of mismatched RC components to a large extent, because the filter transfer function is dependent on the ratio of two capacitors, rather than on the absolute values of capacitors and resistors. Thus, variations in manufacturing tolerances and external effects such as temperature are less problematic. The switched capacitor filters known in the arts, however, are relatively inefficient in terms of power consumption and area requirements. Larger area requirements generally also lead to increased costs.

An approach to enhancing frequency selectivity and decreasing noise is the current-mode quadrature sampling mixer. Instead of taking quadrature samples directly from an IF or RF voltage input signal, as a proxy for the voltage signal, a current proportional to the signal is produced by a transconductive element. A switched capacitor network is then used to integrate the current into the sampling capacitors. This type of switched capacitor network encounters the same problems of power consumption and cost as other switched capacitor networks, due in large part to its reliance on the use of op amps.

One of the more advanced filter solutions known in the arts includes the use of cascaded passive IIR filter stages combined with direct sampling and mixing. Such techniques provide the same functionality as cascaded RC filters, but offer improvements in controlling the filtering characteristics by avoiding the problems associated with component mismatch. Avoiding the use of op amps also reduces power consumption. One such approach is discussed in related patent application, Ser. No. ______ (attorney docket number TI-34776), which is incorporated herein in its entirety for all purposes by this reference. Such an approach has been limited to real filtering however.

Due to these and other challenges in implementing filtering and image rejection, it would be useful and desirable in the arts to provide improved methods and circuits adaptable to IF and RF applications. Complex filtering and image rejection methods and devices would be advantageous for use with high frequency signals and resistant to noise degradation while maintaining low power consumption, reduced area, and reduced costs.

### SUMMARY OF THE INVENTION

In carrying out the principles of the present invention, in accordance with preferred embodiments thereof, methods and circuits are provided for complex filtering in a multi-tap direct sampling mixer (MTDSM). The complex filters realized by the methods and circuits of the invention provide technical advantages over the prior art.

According to one aspect of the invention, a method for complex filtering in a direct sampling mixer includes steps for implementing a bandpass filter characteristic whereby an RF image is substantially rejected. According to the steps, an RF input is sampled with multiple phases of a local oscillator clock, each of the local oscillator phases producing a discrete-time signal stream. The multiple phases of the discrete-time signal are processed in multiple paths, the paths sharing among themselves the discrete-time samples.

According to another aspect of the invention, preferred methods are described including steps for sampling an RF input with I and Q phases of a local oscillator clock, each of the phases producing a stream of charge packets. Further steps include processing the I and Q charge packets in separate signal processing paths, and sharing the I and Q charge packets between the signal processing paths, whereby a bandpass filter characteristic is achieved and RF image is substantially rejected.

According to still another aspect of the invention, an example of a preferred embodiment of a system for complex filtering of a high frequency input signal, includes four single-pole IIR filters for sampling I+, I−, Q+, and Q− phases of an input signal. The IIR filters are interconnected for rotation of the filtered signals such that in combination the interconnected single-pole IIR filters provide a complex filter system.

According to another aspect of the invention, a preferred embodiment provides a circuit for image rejection filtering in a direct sampling mixer. The circuit includes an IIR filter coupled to an input node, the IIR filter having a buffer capacitor for buffering input current, rotating capacitors coupled to the buffer capacitors in a configuration for reading phase signal components in rotation and for providing mixed filtered phase signal component outputs to four parallel output nodes.

Additional preferred embodiments of the invention are described in which a cascaded arrangement is used to provide a high order filter with more than one stage of complex filtering.

Further preferred embodiments of the invention are described in which one or more transconductive, amplifier, or buffer elements are coupled between cascaded stages of a high order complex filter.

According to additional preferred embodiments of the invention, it is contemplated that complex filters according to the invention will be used as loop filters within sigma-delta analog-to-digital converters.

The invention provides technical advantages including but not limited to a reduction in dynamic range requirements of downstream circuitry, such as for example IF amplifiers, and reduction in device power requirements, chip area, and cost. These and other features, advantages, and benefits of the present invention will become apparent to one of ordinary skill in the art upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 is a schematic block diagram illustrating an example of the practice of the invention;

FIG. 2 (prior art) is a schematic diagram illustrating an example of a real filter which may be used in the practice of preferred embodiments of the invention;

FIG. 3 is a schematic block diagram of an example of a circuit demonstrating the practice of the invention;

FIG. 4 is a schematic block diagram showing a conceptual view of an example of the architecture of the practice of the invention; high-pass polyphase filter that will be turned into a discrete-time high-pass or band-pass filter.

FIGS. 5A through 5D are a series of schematic diagrams illustrating a direct sampling mixer method and high-pass filter circuit and its operation according to a preferred embodiment of the invention; and

FIG. 6 is a graphical representation of transfer functions of direct sampling mixer methods and circuits according to examples of preferred embodiments of the invention.

References in the detailed description correspond to like references in the figures unless otherwise noted. Like numerals refer to like parts throughout the various figures. Descriptive and directional terms used in the written description such as first. second, left, right, etc., refer to the drawings themselves as laid out on the paper and not to physical limitations of the invention unless specifically noted. The drawings are not to scale, and some features of embodiments shown and discussed are simplified or amplified for illustrating the principles, features, and advantages of the invention.

### DETAILED DESCRIPTION OF PREFERRED EMBODIMENTS

In general, the preferred embodiments of the invention provide band-pass and image reject filtering in a direct sampling mixer of an IF or RF system. This is accomplished by the use of rotating capacitors among the in-phase I and quadrature Q branches of the system, denoted I+, I−, Q+, Q−, respectively. The exchange of information among the branches of the I and Q channels enables the implementation of a complex filter. It should be appreciated that preferred embodiments of the invention may be implemented without the use of op amps.

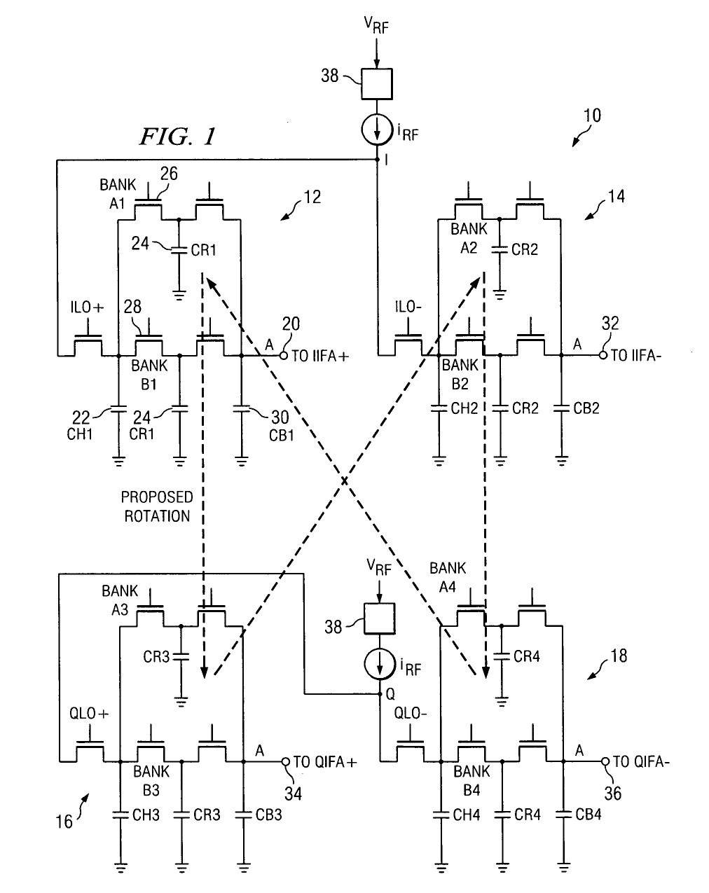

Referring primarily to FIG. 1, the methods of the invention are portrayed in a block diagram in which it can be seen that rotation of a switched capacitor C_{R} between the I and Q channels of the circuit causes a sharing of the charge among the four paths, I+, I−, Q+, Q−, resulting in a direct sampling and a complex filtering arrangement 10. The preferred embodiment of the filter 10 shown can be seen to have four sub-circuits 12, 14, 16, 18, which may be understood as single-pole IIR filters. Understanding of the present invention may be enhanced by an overview of the workings of one such sub-circuit 12 of the filter 10. A more detailed explanation of the filtering methods and exemplary sub-circuits 12, 14, 16, 18 may be found in patent application, Ser. No. ______ (attorney docket number TI-34776), which is incorporated herein in its entirety for all purposes by reference.

Initially focusing exclusively on sub-circuit 12, a signal is output at node 20 and the sub-circuit 12 functions as follows: A history capacitor C_{H1} 22 is charged along with a rotating capacitor C_{R1} 24 of capacitor bank A1 26, preferably for 32 periods of the RF waveform. Meanwhile, charge stored in capacitor bank B1 28 is allowed to discharge to a buffer capacitor C_{B1} 30. During the next 32 periods of the RF waveform, capacitor bank A1 26 is allowed to discharge to the buffer capacitor C_{B1} 30 while capacitor bank B1 28, discharged from the previous cycle of 32 periods, collects new charge along with the history capacitor C_{H1} 22. Repetition of this sequence provides a first-order IIR filter with a pole determined by the ratio of the rotating capacitor C_{R1} 24 to the sum of C_{R1} and the history capacitor C_{H1} 22. The second first-order IIR filter is created through the charge-sharing interaction of the rotating capacitor C_{R1} 24 with the history capacitor C_{H1} 22. It should be understood that throughout the Figures and description, the references C_{R}, C_{H}, and C_{B} are used to refer to rotating capacitors, history capacitors and buffer capacitors respectively. Numerical designations are added for clarity in referring to associated elements such as C_{R1}, C_{H1}, etc.

A prior stage of filtering is obtained when the rotating capacitor C_{R1} 24 is allowed to share the charge with the history capacitor C_{H1} 22. Passive charge sharing permits the charge previously held on the buffer capacitor C_{B1} 30 to be shared with the new charge on the rotating capacitor C_{R1} 24 in a proportion according to their ratio, C_{R1}/(C_{R1}+C_{B1}). Since the buffer capacitor C_{B1} 30 is never allowed to discharge, it retains a memory representative of previous samples and performs the second stage of IIR filtering. The pole of this second stage filter may be selected by choosing the ratio of the rotating capacitor C_{R1} 24 to the sum of C_{R1} and the buffer capacitor C_{B1} 30.

A cascaded filter having numerous single-pole IIR filter stages is based on the principle of maintaining a unidirectional flow of information and disallowing feedback from a later stage to an earlier stage. This may be accomplished by completely discharging a rotating capacitor C_{R} before recharging it in the next sampling cycle with a history capacitor C_{H}. The rotating capacitor C_{R} is used as a charge-transferring mechanism that transfers charge from the earlier stage output to the subsequent stage input, and is reset before it is again permitted to pass charge from the output of the earlier stage. This principle may be extended to provide additional IIR filtering stages. Further description of the details of cascading is provided in the referenced related patent application.

Now referring to the complex filter 10 of FIG. 1, it may be appreciated that the preferred embodiment shown and described contains four two-pole IIR filters 12, 14, 16, 18. Two of the filters 12, 14, are connected to the I+ and I− nodes, 20, 32 of an RF system (not shown), and two filters 16, 18 are connected to the Q+ and Q− nodes 34, 36. The filter sub-circuits 12, 14, 16, 18 are also interconnected to provide complex filtering by rotating among their capacitors in order to share information among the I and Q branches of the circuit 10. Preferably, an input voltage such as an RF signal, V_{RF}, is converted to a corresponding current, i_{RF}, using a suitable transconductive element 38 as is known in the arts. It has been found that the rotation and integration on C_{H} results in a lossy complex integrator 10 in which feedback is provided to each opposing I and Q channel by a factor described by the expression C_{R}/(C_{H}+C_{R}) [Expression 1], providing a single-pole complex IIR filter with a pole located at C_{H}/(C_{H}+C_{R})+j[C_{R}/(C_{H}+C_{R})], [Expression 2], where j represents the square root of negative one. As a consequence of this operation, the passband of the lossy integrator 10 is moved to the positive frequencies while the negative frequencies fall in the stopband of the filter 10. It should be noted that by simply rotating C_{R} between the I and Q branches in the opposite direction, the same methods may be used to provide a filter with positive frequencies in the stopband and negative frequencies in the passband without departing from the concept of the invention. Preferably, such filtering is performed together with the down-conversion process in an RF system, eliminating the need for subsequent image rejection operations.

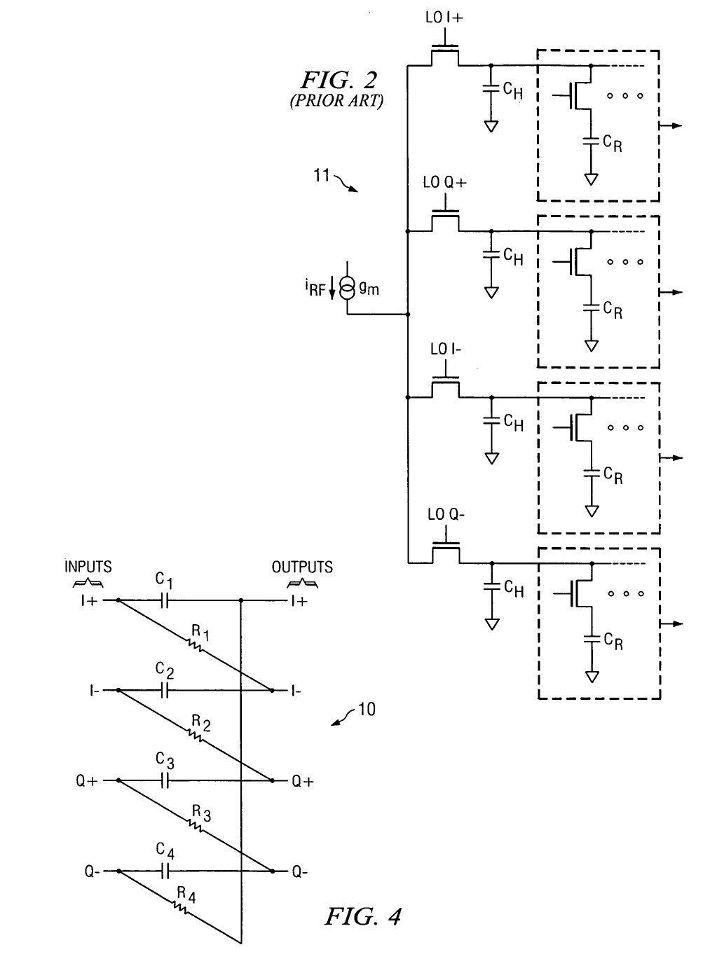

FIG. 2 (prior art) shows the I/Q top level MTDSM structure 11 as in the example of the referenced related patent application. The use of the rotating capacitors C_{R} improves upon the passive implementation of a real filter, but lacks the ability to perform band-pass filtering in the complex domain.

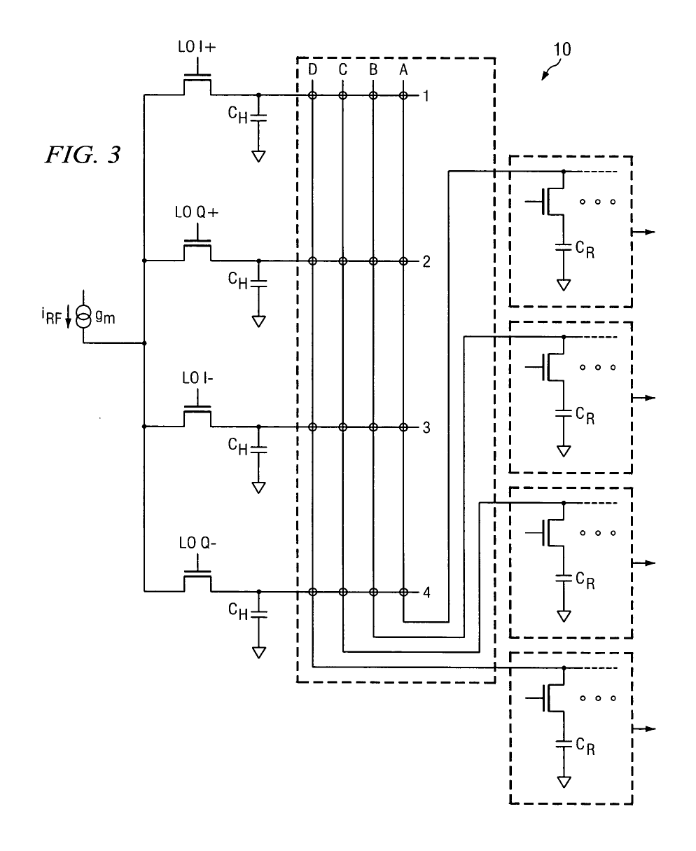

FIG. 3 shows an example of the I/Q top-level MTDSM architecture 10 of the invention arranged for performing complex filtering by allowing the sharing of charge samples across the paths I+, I−, Q+, Q−. For example, the Q− rotating capacitor C_{R} may be connected to the I+ history capacitor C_{H}. This arrangement provides the capability of effectively changing the sampling frequency. The interconnections between the history capacitors and rotating capacitors are controlled by a switching matrix, {(a,b,c,d)×(1,2,3,4)}. The operation of the complex filter can be seen with further reference to Table 1. The baseline of the real-valued filtering, as shown in FIG. 2, is maintained when the switches a1, b2, c3, and d4 are on and the others are off. If the pairing between C_{H} and C_{R} is skewed, for example for the switch matrix configuration a2, b3, c4, and d1, the MTDSM still performs real-valued filtering, but the phase of the demodulated signal is offset by π/2. In practical wireless communications applications however, the absolute phase is not measurable so the two example static configurations discussed would be indistinguishable. Because of the spatial separation of the receiver and transmitter, only the relative phase changes would be measurable. All four configurations of the switch matrix are summarized in Table 1.

TABLE 1

| | | | |
|---|---|---|---|
| a1 | b2 | c3 | d4 |
| a2 | b3 | c4 | d1 |
| a3 | b4 | c1 | d2 |
| a4 | b1 | c2 | d3 |

Complex filtering is realized by rotating through the matrix in the sequence shown by the rows of Table 1. For example, beginning with a first arbitrary instant of time, the switches a1, b2, c3, and d4 are in the “on” state; at the next instant, switches a2, b3, c4, and d1 are “on”; and so on. By rotating through the rows, a band-pass transfer function is defined with a center frequency determined by the rotation speed, i.e., inverse of RF or LO cycles per rotation step. Selection between positive and negative frequency offsets may be accomplished by selecting the direction of rotation. It should be appreciated that the switch matrix is not required to be physically separated from the rotating capacitor C_{R} and history capacitor C_{H} array structure, e.g.; FIG. 3. The switches may be merged with the rotating capacitor C_{R}-coupled switches. The baseline of the real-valued filtering may also be high-pass instead of band-pass as in the above example.

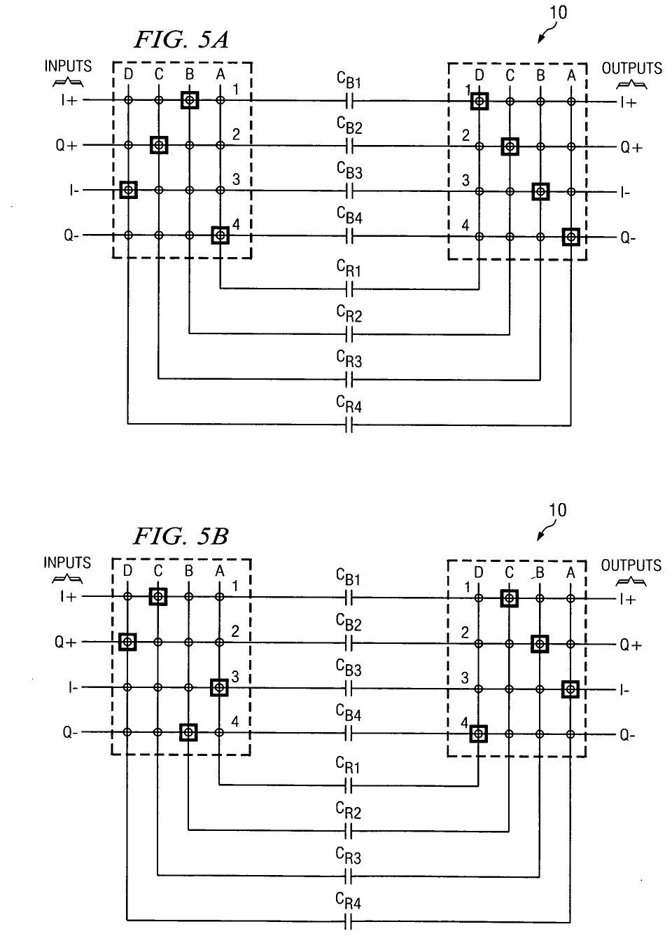

FIG. 4 is an example of an implementation of a high-pass polyphase filter useful in understanding the invention. The implementation of FIG. 4 shows the polyphase filter constructed using passive resistors R and capacitors C. Alternatively, switched capacitors may be substituted for the resistors R and rotated temporally. Substituting for R₁ though R₄, switched capacitors C_{R} may be rotated cyclically, C_{R1}, C_{R2}, C_{R3}, C_{R4}, C_{R1} . . . , and so forth, while distributing the input charges. In this way, the rotating capacitors C_{R} may each be connected with any of the history capacitors C_{H}, and buffer capacitors C_{B} (e.g., C₁, C₂, C₃, C₄) associated with each quadrature phase, I+, Q+, I−, Q−. If, for example, the active rotating capacitor of the four quadrature phases shift by one history capacitor C_{H} with each LO cycle, the received frequency would be shifted, up or down depending on direction of rotation, by one-fourth. For a precise frequency offset, a dithered selection may also be used. Of course, in order to preserve the quadrature signaling, it would be required to switch the active rotating capacitors in tandem.

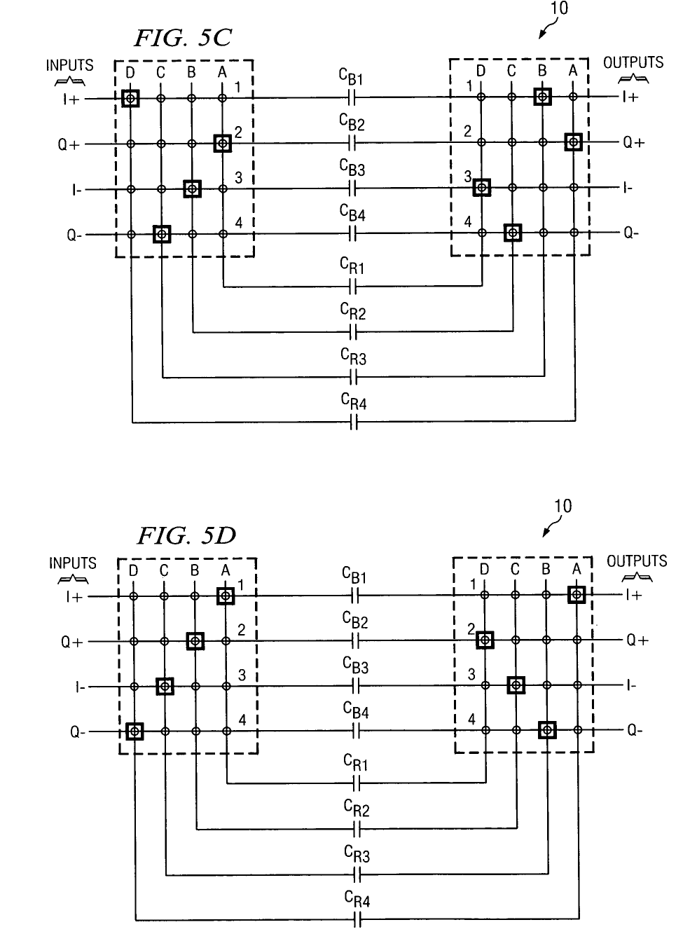

FIGS. 5A through 5D depict the progression of the switching sequence to illustrate an example of a preferred direct sampling mixer 10 circuit and method embodying the invention with predominantly high-pass filtering. The four input nodes indicated by I+, Q+, I−, and Q−, accept the input signal for sampling. Four buffer capacitors, C_{B1}, C_{B2}, C_{B3}, C_{B4}, are coupled to the input nodes I+, Q+, I−, Q, respectively. The buffer capacitors, C_{B1}, C_{B2}, C_{B3}, C_{B4}, are in turn coupled to rotating capacitors, C_{R1}, C_{R2}, C_{R3}, C_{R4}, in a configuration that enables them to be individually switched “on” and “off” according to the phase of the input signal using a matrix of switches, {(a,b,c,d)×(1,2,3,4)}, as denoted in Table 1, typically implemented using MOS transistors.

Thus, referring to FIGS. 5A through 5D, in conjunction with Table 1, it can be seen that a rotation among the switched capacitors C_{Rn} is provided such that a complex filter 10 is implemented. Selection of the ratio of capacitors C_{R} and C_{H} determines the filtering characteristics of the filter 10. The results are output to parallel output nodes, for further processing or additional cascaded filtering stages.

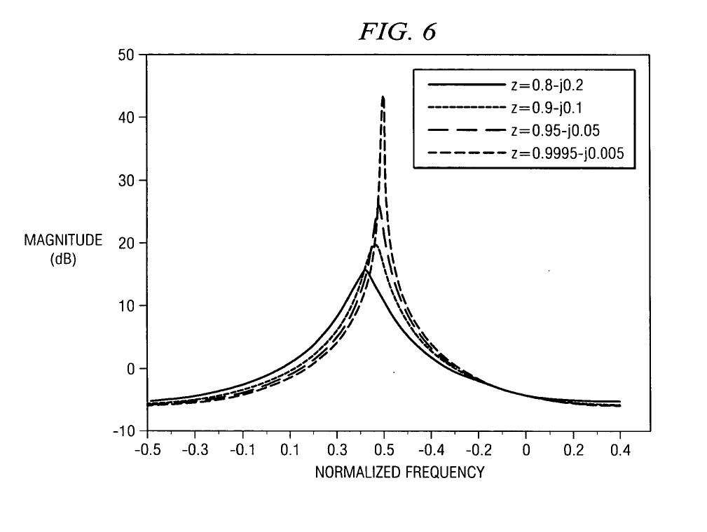

It should be understood that the complex filter transfer function is dependent upon the ratio of C_{R} to C_{H}. A graphical depiction of the transfer functions of example circuits implemented according to the invention is shown in FIG. 6. It should also be appreciated by those skilled in the arts that the transfer function may be controlled by the rotation speed.

The complex filtering arrangement as shown and described may be repeated two or more stages in a cascading arrangement in the same manner as filters are commonly cascaded in the arts, in order to provide enhanced filtering capabilities. Each cascaded stage functions as described, providing two or more complex filter stages 10. In principle, an infinite number of stages 10 according to the invention may be cascaded, although in practice, fewer stages will be used. It should also be appreciated by those skilled in the arts that in some applications it may be desirable to incorporate additional electronic circuit elements, for example, transconductive, amplifying, or buffer elements, between cascaded stages of complex filters implemented according to the invention in order to provide increasingly high order complex filters.

Thus, the invention provides image rejection filtering in a direct sampling mixer. The invention may be readily applied to signal processing applications with favorable power and cost savings and avoidance of dependency on the matching of individual circuit components. While the invention has been described with reference to certain illustrative embodiments in an IF or RF environment, the methods and devices described are not intended to be construed in a limiting sense. Various modifications and combinations of the illustrative embodiments as well as other advantages and embodiments of the invention will be apparent to persons skilled in the art upon reference to the description and claims.

1. A method for complex image rejection filtering in a direct sampling mixer comprising the steps of:
sampling an RF input with multiple phases of a local oscillator clock, each of the local oscillator phases producing a discrete-time signal stream;
processing the multiple phases of the discrete-time signal in multiple paths, the paths sharing among themselves the discrete-time samples, whereby a bandpass filter characteristic is achieved during the processing step, and whereby an RF image is substantially rejected.

2. A method according to claim 1 wherein the multiple phases of the local oscillator clock comprise two phases I and Q spaced approximately 90 degrees apart.

3. A method according to claim 1 wherein the multiple phases of the local oscillator clock consist of four phases I+, I−, Q+, Q−, spaced approximately 90 degrees apart.

4. A method according to claim 1 wherein the discrete-time signal stream comprises charge packets.

5. A method according to claim 1 wherein the step of sharing discrete-time samples further comprises the sharing of charge packets.

6. A method according to claim 1 further comprising the step of converting an RF input voltage into current.

7. A method for complex filtering in a direct sampling mixer comprising:
sampling an RF input with I and Q phases of a local oscillator clock, each of the phases producing a stream of charge packets,
processing the I and Q charge packets in separate signal processing paths,
sharing the I and Q charge packets between the signal processing paths, whereby a bandpass filter characteristic is achieved during the processing step, and whereby an RF image is substantially rejected.

8. A complex filter system for filtering a high frequency input signal, the complex filter comprising:
a first IIR filter for sampling an I+ phase of the input signal;
a second IIR filter for sampling an I− phase of the input signal;
a third IIR filter for sampling an Q+ phase of the input signal;
a fourth IIR filter for sampling an Q− phase of the input signal;
wherein the IIR filters are interconnected for rotation of filtered signals such that in combination the interconnected IIR filters provide a complex filter.

9. A complex filter system for filtering a high frequency input signal according to claim 8 wherein each IIR filter further comprises a history capacitor, rotating capacitor, and buffer capacitor adapted for sampling, storing and transferring charge from the input signal; and
wherein each IIR filter has a pole determined by the ratio of its rotating capacitor to its history capacitor and is adapted to provide filtering of an input signal.

10. A complex filter system for filtering a high frequency input signal comprising:
two or more complex filter stages according to claim 8 coupled in a cascading configuration for providing high order filtering.

11. A complex filter system according to claim 10 further comprising one or more transconductive elements coupled between adjacent stages.

12. A complex filter system according to claim 10 further comprising one or more amplifier elements coupled between adjacent stages.

13. A complex filter system according to claim 10 further comprising one or more buffer elements coupled between adjacent stages.

14. A complex filter system according to claim 9 wherein the system has a pole described by,
C_{H}/(C_{H}+C_{R})+j[C_{R}/(C_{H}+C_{R})], [Expression 2],
wherein;
C_{R}=rotating capacitor;
C_{H}=history capacitor.

15. A complex filter system according to claim 8 wherein the complex filter comprises a loop filter in a sigma-delta analog-to-digital converter.

16. A circuit for image rejection filtering in a direct sampling mixer comprising:
an input node,
four parallel output nodes for producing four phases of an output signal;
coupled to the input node, an IIR filter further comprising:
a buffer capacitor for buffering input current;
rotating capacitors coupled to the buffer capacitors in a configuration for reading the phase signal components in rotation and for providing mixed filtered phase signal component outputs to the output nodes.

17. A circuit according to claim 16 wherein the direct sampling mixer comprises a sigma-delta analog-to-digital converter.

18. A circuit for image rejection filtering in a direct sampling mixer comprising two or more circuit stages according to claim 16 coupled in a cascaded configuration.

19. A circuit for image rejection filtering in a direct sampling mixer according to claim 18 further comprising one or more transconductive elements coupled between adjacent stages.

20. A circuit for image rejection filtering in a direct sampling mixer according to claim 18 further comprising one or more amplifier elements coupled between adjacent stages.

21. A circuit for image rejection filtering in a direct sampling mixer according to claim 18 further comprising one or more buffer elements coupled between adjacent stages.
